(19) United States
(12) Patent Application Publication
(10) Pub. No.: US 2024/0381440 A1
(43) Pub. Date: Nov. 14, 2024

(54) DYNAMIC RACH CONFIGURATION FOR NETWORK ENERGY SAVING

(71) Applicant: TELEFONAKTIEBOLAGET LM ERICSSON (PUBL), STOCKHOLM (SE)

(72) Inventors: Xu ZHU, Yokohama (JP); Ali NADER, Malmö (SE); Ilmiawan SHUBHI, Malmö (SE); Andres REIAL, Höllviken (SE); Sina MALEKI, Malmö (SE)

(21) Appl. No.: 18/690,953

(22) PCT Filed: Sep. 10, 2022
(86) PCT No.: PCT/IB2022/058535

§ 371 Date: Mar. 11, 2024

Related U.S. Application Data
(60) Provisional application No. 63/242,763, filed on Sep. 10, 2021.

(51) Int. Cl. H04W 74/0833; H04W 48/08; H04W 76/10; H04W 76/38

(52) U.S. Cl. CPC H04W 74/0833; H04W 48/08; H04W 76/10; H04W 76/38

(57) ABSTRACT

Systems and methods for enabling energy efficient Random Access Channel (RACH) are provided. A method performed by a network node includes one or more of: being configured with an original RACH configuration; receiving a preamble in a RACH Occasion; dynamically changing a RACH-configuration period and/or RACH frequency multiplexing configuration according to whether a preamble was received; reconfiguring to a performance optimized configuration; starting one or more timers: keeping the current RACH configuration until the timer(s) reaches the specified time; if fewer than a threshold preambles are received, reconfiguring with the original PRACH configuration; and if more than a threshold preamble are received, resetting and/or restarting a running timer. An energy efficient RACH configuration allows the network node receivers to have a longer sleep time and operate over a narrower bandwidth. As such more energy is saved when the network is in idle mode and there are no/little RACH attempts.

### RELATED APPLICATIONS

This application claims the benefit of provisional patent application Ser. No. 63/242,763, filed Sep. 10, 2021, the disclosure of which is hereby incorporated herein by reference in its entirety.

### TECHNICAL FIELD

The present disclosure relates generally to Random Access Channel (RACH) configuration.

### BACKGROUND

### Network Energy Consumption

Network power consumption in New Radio (NR) has increased significantly compared to Long Term Evolution (LTE), partly due to higher bandwidth and massive number of antennas. This is still evident even if there are no UEs present in a cell. Although there is no UL or DL transmission between a specific UE and a gNB in idle mode, the gNB still needs to periodically transmit signals, such as SSB and broadcast system information, e.g., SIB1. For example, SSBs can be configured with 20 ms periodicity, and SIB1 can be configured with 160 ms periodicity. In addition, the gNB also needs to periodically monitor the preambles from a UE to cope with random access, which implies that the receiver components of the gNB need to be turned on periodically, e.g., every 10 ms or less. Hence, although increasing the sleep time of a gNB can reduce the network energy consumption, the sleep time of the gNB is constrained by the periodicity of transmit and receive.

### RACH Configuration

In the case of a UE making an initial access to a network from the idle/inactivate state, the UE transmits a preamble through PRACH to start a random-access procedure as per TS 38.331, and TS 38.321. The details of the preamble are given by the RACH configuration provided by SIB1, e.g., preamble format and RACH Occasion as per TS 38.331, and TS 38.213. For the UE in its serving cell, the configuration parameter prach-ConfigurationIndex defines the preamble format that is active (to be used by the UE) and the time-domain position of the PRACH Occasions. The parameters msg1-FrequencyStart and msg1-FDM define the frequency domain positions for the PRACH transmissions in case frequency multiplexing of PRACH is used in the cell. The parameter ssb-perRACH-OccasionAndCB-PreamblesPerSSB specifies the mapping between SSBs and RACH time/frequency Occasions. The preamble used by the UE may only be transmitted at specified RACH Occasions. Each RACH Occasion is a part of a RACH slot. The preamble transmission can only take place within a subset of slots (RACH slots) within a specific frame. This RACH slots repeat every RACH-configuration period until RACH configuration is updated by SIB 1 as per TS 38.213. For example, if RACH-configuration period =10 ms, that is, there are RACH slots in every frame. Hence, the gNB receivers must be activated at least every 10 ms, which means the sleep time of the gNB does not exceed 10 ms, since there might be multiple RACH slots in one frame or multiple RACH Occasions in one RACH slot. RACH slots repeat every RACH-configuration period until RACH configuration is updated, the gNB inevitably consumes energy periodically for receiving preambles even if there are no UEs present in a cell. As mentioned, the RACH Occasions may further be increased by the network through frequency multiplexing. Up to 8 such frequency multiplexed RACH Occasions may be configured by the network per time occasion. These frequency RACH Occasions each consume multiple PRBs (up to 24 PRBs each depending on subcarrier spacing used in the cell) and are contiguous in frequency.

In addition, the preamble transmission may be carried out repeatedly with increased transmission power if a Random-Access Response (RAR) is not received within a predetermined window as per TS 38.321. The re-transmitted preamble is still sent in the RACH Occasions corresponding to the SSB to which the preamble belongs.

There currently exist certain challenge(s). Improved systems and methods for energy efficient RACH are needed.

### SUMMARY

Systems and methods for enabling energy efficient Random Access Channel (RACH) are provided. In some embodiments, a method performed by a network node for enabling energy efficient RACH includes one or more of: being configured with an original RACH configuration; receiving a preamble in a RACH Occasion of the network node; dynamically changing a RACH-configuration period and/or RACH frequency multiplexing configuration according to whether a preamble was received in a RACH Occasion; reconfiguring to a performance optimized configuration with a RACH-configuration period which is smaller than the previous one and/or with more Physical RACH (PRACH) occasions in frequency; starting one or more timers associated with the configured parameters; keeping the current RACH configuration until the timer(s) reaches the specified time; if no other, or fewer than a threshold, preambles are received before the timer runs out, reconfiguring with the original PRACH configuration; and if any other or more than a threshold preamble are received before the timer runs out, resetting and/or restarting a running timer.

An energy efficient RACH configuration implies that the gNB receivers can have a longer sleep time and operate over a narrower bandwidth. As such a network can save more energy when the network is in idle mode and there are no/little RACH attempts. Once a/few preamble(s) is/are received which entails that RACH is ongoing, a reconfigured RACH configuration to a performance optimized one provides more RACH Occasions for higher RACH efficiency and capability. If there is no other RACH request after a period, the RACH configuration returns to an energy efficient configuration, reducing the gNB energy consumption.

In some embodiments, a method performed by a User Equipment (UE) for enabling energy efficient RACH includes one or more of: transmitting a preamble in a RACH Occasion of a network node; and determining whether a RACH-configuration period and/or RACH frequency multiplexing configuration was dynamically changed according to whether a preamble was received in a RACH Occasion.

In some embodiments, the original RACH configuration comprises an energy efficient RACH configuration. In some embodiments, the current RACH configuration comprises a performance-optimized RACH configuration.

In some embodiments, configuration adaptation is based on/weighted towards type of the UE/access when one or more of: where adaptation from energy-efficient to performance-optimized configuration is done sooner when a delay-sensitive UE accesses the network whereas such adaptation may take place later in case a delay-tolerant type of UE accesses the network; where the type of UE/access is identified by network's higher layers during or after connection setup; and where type of UE/access is identified by network upon UE access initiation based on access-specific preambles.

In some embodiments, configuration being performed sooner comprises performing when zero or a small threshold for number of UEs of such type accessing. In some embodiments, configuration being performed later comprises performing when a higher threshold for number of users or no adaptation at all.

In some embodiments, the adaptations between energy efficient vs performance optimized configurations are done based on time schedules derived from a network node's learnings of “few access attempt”-hours vs “busy access attempt”-hours.

In some embodiments, “few access attempt”-hours comprises fewer than a threshold and “busy access attempt”-hours comprises more accesses than the threshold. In some embodiments, the number of preambles thresholds or timer settings are adapted based on the network node learning info.

In some embodiments, the network node comprises a gNB.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a high-level description of the idea where the gNB reconfigures the Random Access Channel (RACH) Configuration between “energy-optimized” vs “performance-optimized,” according to some embodiments of the current disclosure;

FIG. 2 illustrates an example of a Performance-optimized RACH configuration, according to some embodiments of the current disclosure;

FIG. 3 illustrates an example of an Energy-optimized RACH configuration, according to some embodiments of the current disclosure;

FIG. 4 illustrates a dynamic change of RACH configurations between Performance-/Energy-optimized configurations, according to some embodiments of the current disclosure;

FIG. 5 illustrates a dynamic change of Physical Random Access Channel (PRACH) configurations between Performance-/Energy-optimized configurations including multiple User Equipment (UE) accesses during the Performance-optimized configuration, according to some embodiments of the current disclosure;

FIG. 6 illustrates a method performed by a user equipment for enabling energy efficient RACH, according to some embodiments of the current disclosure;

FIG. 7 illustrates a method performed by a network node for enabling energy efficient RACH, according to some embodiments of the current disclosure;

FIG. 8 shows an example of a communication system in accordance with some embodiments;

FIG. 9 shows a UE in accordance with some embodiments;

FIG. 10 shows a network node in accordance with some embodiments;

FIG. 11 is a block diagram of a host, which may be an embodiment of the host of FIG. 8, in accordance with various aspects described herein;

FIG. 12 is a block diagram illustrating a virtualization environment in which functions implemented by some embodiments may be virtualized; and

FIG. 13 shows a communication diagram of a host communicating via a network node with a UE over a partially wireless connection in accordance with some embodiments.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

An extended Random Access Channel (RACH)-configuration period implies that the receivers can have a longer sleep time and the network can save more energy. For example, if both RACH-configuration period and System Information Block 1 (SIB1) is configured with 160 ms periodicity, there is only one RACH frame before SIB1 is updated and energy saving efficiency is greatly improved. Likewise, configuring few/no frequency multiplexed PRACH resources would allow the network to tune in the receiver to a narrower bandwidth (fewer Physical Resource Blocks (PRBs)) for Physical RACH (PRACH) detection and thereby save energy.

However, an extended RACH-configuration period and few frequency-multiplexed PRACH resources also imply that the RACH opportunities are reduced for the UEs of the cell, and the time required for UE accessing the network through PRACH is prolonged (i.e., increased access latency). For example, if both RACH-configuration period and SIB1 is configured with 160 ms periodicity, and a User Equipment (UE) does not receive a RAR after it transmitted its preamble at specific RACH Occasion, then this UE need wait for at least 160 ms for its next RACH Occasion.

Certain embodiments may provide one or more of the following technical advantage(s). An energy efficient RACH configuration implies that the gNB receivers can have a longer sleep time and operate over a narrower bandwidth. As such a network can save more energy when the network is in idle mode and there are no/little RACH attempts. Once a/few preamble(s) is/are received which entails that RACH is ongoing, a reconfigured RACH configuration to a performance optimized one provides more RACH Occasions for higher RACH efficiency and capability. If there is no other RACH request after a period, the RACH configuration returns to an energy efficient configuration, reducing the gNB energy consumption.

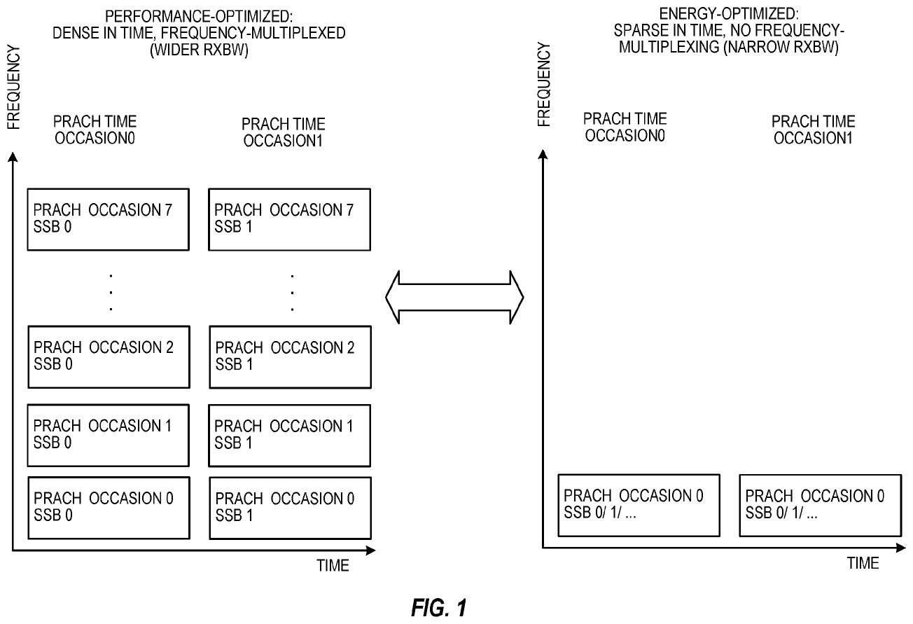

For a gNB, the occasion of an actual used RACH attempt's time and frequency occasion used by the UE is unknown, so a static RACH configuration can't guarantee RACH efficiency and energy saving efficiency simultaneously. The present invention introduces methods for reducing network energy consumption caused by the receiver for decoding PRACH for the sake UE random access attempt. More specifically, the gNB operates with two or more RACH configurations at different time instances. FIG. 1 illustrates a high-level description of the idea where the gNB reconfigures the RACH Configuration between “energy-optimized” vs “performance-optimized,” according to some embodiments of the current disclosure. As used herein, “energy-efficient” is sometimes used to refer to “energy-optimized”. Two such configurations are depicted in FIG. 1 in which both a Performance-optimized configuration and an Energy-optimized RACH configuration are visualized. The performance-optimized configuration includes multiple RACH occasions densely provided both in frequency and time. Such configuration is suitable for handling many UL requests from different UEs with minimal response delay. As an example, eight PRACH resources are multiplexed in frequency and every 10 ms in time. Such configuration comes however at the cost of gNB having to often listen (having the receive running) over a wider bandwidth. The Energy-optimized configuration on the other hand provides only a few resources in frequency and time. Such configuration is more suitable for deployments (e.g., locations with low traffic, or small cells only handling few UEs), times of day, or occasions during which only a few UEs access the cell or alternately many UEs accessing the cell but the UEs are of such type that can tolerate long delays for accessing the cell (e.g., delay tolerant sensors). As an example of such configuration, one PRACH resource is made available in frequency and every 160 ms or more in time. Such configuration may be resource limited but helps the gNB to conserve energy as the gNB only needs to have its receiver on occasionally and over a narrower bandwidth. It shall be noted that throughout the present invention only two configurations and transitions in-between are exemplified for the sake of simplicity. There may however be multiple configurations implemented in a network wherein different configurations are activated depending on relative load, e.g., Full-performance-optimized for excessive load and/or for Ultra Reliable Low Latency Communication (URLLC) UEs, a set of semi-performance-optimized configurations for moderate to high load and/or enhanced Mobile Broadband (eMBB) UEs, and energy-optimized configurations for little/no load and/or delay tolerant UEs.

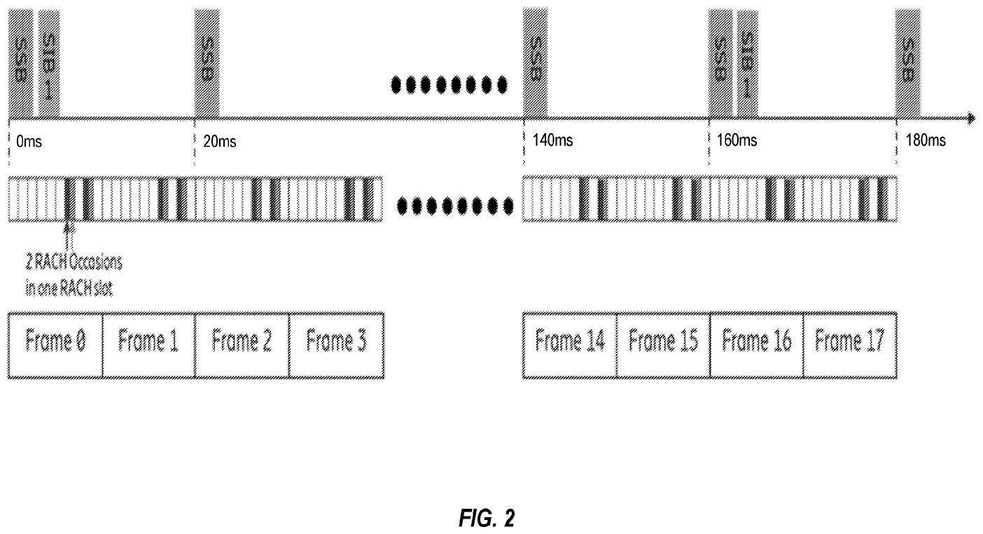

Throughout the remainder of the present invention, the frequency multiplexing aspect is not exemplified in detail for the sake of simplicity. However, it shall be understood that when the time domain configuration is changed to a sparser RACH occasions for the energy-optimized configuration, the number of RACH frequency resources (e.g., configured via the aforementioned parameter: msg1-FDM) may also be reduced and vice versa. The preamble transmission can only take place within RACH slots within a specific frame. So far, these RACH slots repeat every RACH-configuration period until RACH configuration is updated by SIB1. FIG. 2 illustrates an example of a Performance-optimized RACH configuration, according to some embodiments of the current disclosure. In FIG. 2, there are two RACH Occasions in one RACH slot and 2 RACH slots in one RACH frame. RACH-configuration period=10 ms, hence, there are RACH slots in every frame. For the sake of simplicity, potential frequency multiplexed resources are not depicted in the figure, however it shall be understood that multiple resources may have been configured by the network in frequency domain. The gNB inevitably consumes energy periodically for receiving preambles even if there are no UEs present in a cell. In such a configuration, the 10 ms periodicity of RACH occasions, the gNB is left with limited sleeping opportunity in the gaps even no UE is present in the cell, e.g., in one implementation approach, the network may be able to only apply micro-TX sleep meaning to only turn OFF transmitter, while the rest of the gNB circuitry is active and thus it cannot go to deeper sleep levels.

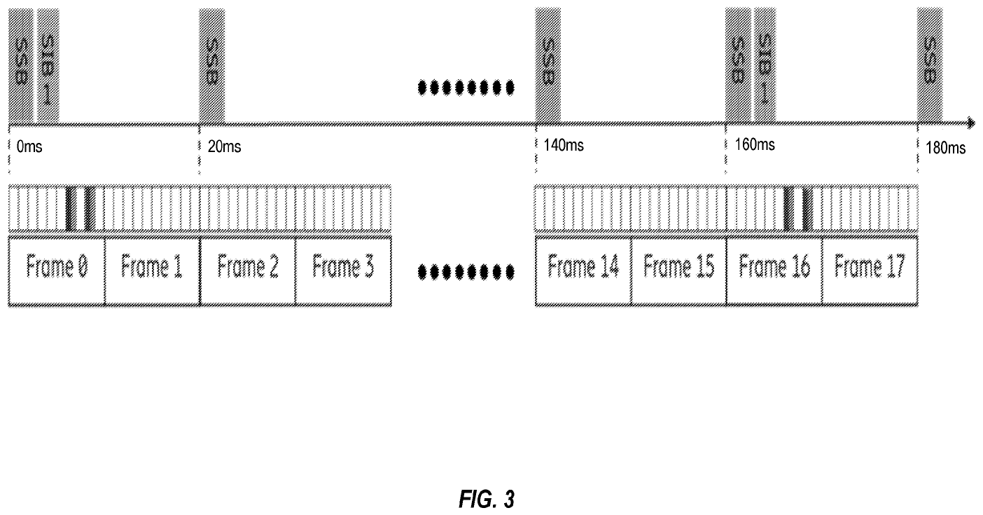

An extended RACH-configuration period implies that the receivers can have a longer sleep time and the network can save more energy. FIG. 3 illustrates an example of an Energy-optimized RACH configuration, according to some embodiments of the current disclosure. In FIG. 3, RACH-configuration period is configured with 160 ms or more and potentially no frequency multiplexing of resources is used, and there is only one RACH frame before SIB1 is updated and energy saving efficiency is greatly improved. However, the preamble transmission may be carried out repeatedly with increased transmission power if a random-access response (RAR) is not received within a predetermined window. The re-transmitted preamble is still sent in the RACH Occasions corresponding to the SSB to which the preamble belongs. Therefore, the extended configuration period will reduce the efficiency of RACH. For example, a UE must wait 160 ms before sending out other preambles.

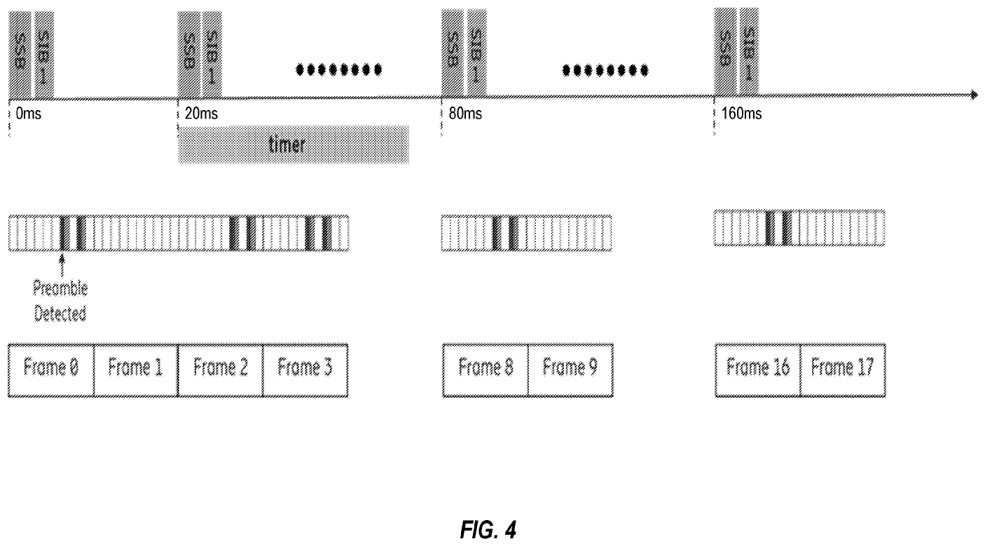

FIG. 4 illustrates a dynamic change of RACH configurations between Performance-/Energy-optimized configurations, according to some embodiments of the current disclosure. A dynamic RACH configuration adaptation is shown in FIG. 4.

In one embodiment, the gNB is initially configured with a first RACH configuration where the first RACH configuration being the Energy-optimized configuration, e.g., containing an extended RACH-configuration period in idle mode.

In one embodiment, the RACH configuration adaptation can be initiated by the reception of a preamble from a UE. Once the gNB receives a preamble from a UE, the gNB may change its RACH configuration to the second RACH configuration. For example, the network may change the PRACH-configuration period to a smaller value, e.g., 10 ms, and potentially includes frequency multiplexing of PRACH resources (i.e., Performance-optimized configuration). Optionally, in applying the second RACH configuration, an application delay may also entail. The application delay, for example, can be described as a maximum time for the network to apply the second RACH configuration after receiving the indication from the UE (i.e., the preamble). The application delay, in one example, can be a predetermined value in the standard. In another example, the application delay may also optionally be based on the values of parameter contained in the first RACH configuration.

In another embodiment, the reception of the preamble may also trigger a start of timer. In one example, the timer may be a predetermined value from a standard. E.g., the timer may be determined as 40 ms, 80 ms, etc. In another example, the value may be configurable in the network, e.g., in SIB1 as part of the first and the second RACH configuration or in another SI broadcasting signal, optionally, having a minimum value being standardized. In yet another example, the value may have a relation with another configuration. E.g., the value of the timer may be an integer or fraction multiplication of the first RACH-configuration period. If no other preamble is received by the gNB until the timer runs out, in one example, the PRACH configuration is restored to the first PRACH configuration. In another example, the PRACH configuration may preserve the second configuration based on current traffic load and the number of UEs

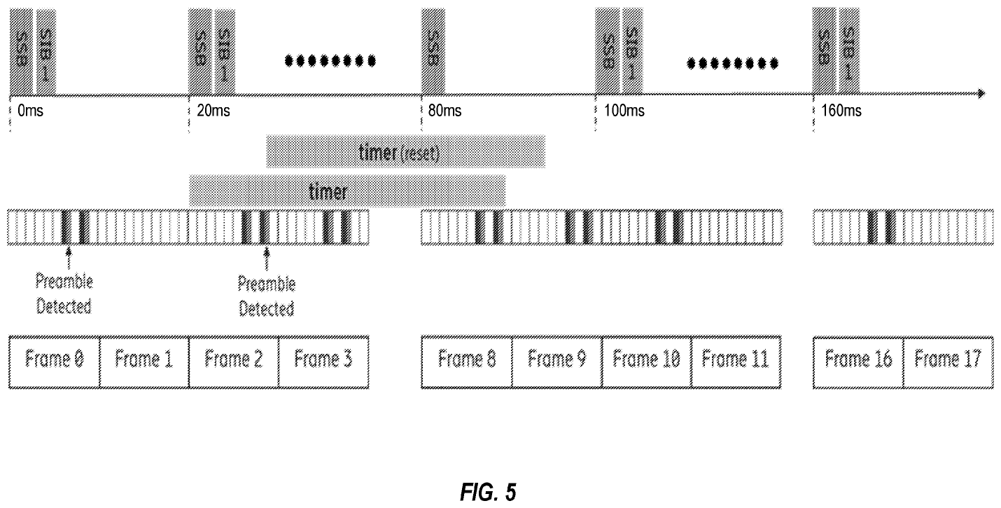

FIG. 5 illustrates a dynamic change of PRACH configurations between Performance-/Energy-optimized configurations including multiple UE accesses during the Performance-optimized configuration. A dynamic RACH configuration adaptation including multiple UE accesses is shown in FIG. 5.

In one embodiment, the reception of the preamble may trigger a start of timer. The timer may be reset and restarted if any other preamble is received before the timer runs out, as shown in FIG. 5. The other preamble can be, for example, received from one or more UEs which try to access the network. If no other preamble is received by the gNB until the timer runs out, in one example, the RACH configuration is restored to the first configuration. In another example, the RACH configuration may preserve the second configuration based on current traffic load and the number of UEs.

In one embodiment of the present invention, the network performs the said configuration changes based on type of UE or type of access performed by the UE. For example, the network may choose to stay in an Energy-optimized configuration (or not restart timers visualized in FIG. 4 and FIG. 5) in case a delay-tolerant type of device or a delay-tolerant access performed by any type of device is performed. Alternately, the network may have a higher tolerance (higher threshold) for number of accesses of such type before changing its configuration. The identification of UE/access type may in one aspect be done through specific preambles. In one example, the network may partition the broadcast preambles and advertise different sets for different access types. Alternately, the access identification may be done by the network at a later stage through higher layer signaling, e.g., in an RRC message during connection setup. In another example, each UE type can be configured with a different preamble, e.g., a time critical UE, can use a specific preamble with a specific signature to indicate its time criticality, and thus if configured, it expects the network to switch to the second RACH configuration, i.e., the performance optimized RACH configuration. The signature can be pre-configured, e.g., as part of the standards or configured by the network e.g., through SIB1 or another SIB.

In one embodiment, the UE receives the first RACH configuration, and the second RACH configuration, with the first RACH configuration being the default RACH configuration. The UE transmits a preamble as configured by the network over a RACH occasion belonging to the first RACH configuration. In one example, the UE expects that the network activates the second RACH configuration following the reception of the preamble and potentially with a validity timer, i.e., upon expiry of the validity timer, the UE cannot assume that the second RACH configuration is active. In another example, the UE can transmit a preamble with a special signature to the network over a first RACH occasion, requesting the network to activate the second PRACH configuration. E.g., if the UE is a time critical UE, or have burst UL traffic and thus needs to have access to more aggressive RACH occasion opportunities.

In one embodiment, the network may limit the dynamics of RACH adaptation, e.g., by setting longer time value, depending on number of the configured paging frames or paging occasions, where more such frames or occasions would lead to longer timer settings or higher thresholds for PRACH mode switching. Because when the RACH configuration is modified according to the invention, e.g., switching to the performance-optimized mode upon receiving a preamble, or to the energy-efficient mode upon timer expiry, the SIB1 contents describing the current RACH configuration are modified and, in legacy systems, a SI update message is broadcasted in the cell via the paging DCI. if the switching of RACH configurations is frequent, the SI update messaging overhead may be high and costly in terms of gNB sleep opportunities.

In another embodiment, to reduce the SI update overhead, multiple RACH configurations may be provided simultaneously, and the network indicates to the UE(s) which of the RACH configuration is active. E.g., as part of RACH configuration provision in SIB1, the network can indicate to the UE(s) if the first or the second RACH configuration is active. In a specific implementation of this example, the network is not required to transmit a SI update if the status of this indication has changed. The UE may then acquire this by its own, e.g., through SIB1 polling or on demand SI content request. In yet another example, the network can indicate the active RACH configuration through other types of signaling, e.g., L1 or L2 signaling (DCI or MAC CE based signaling). E.g., a connected mode UE can receive the indication through a connected mode DCI, (scheduling, non-scheduling DCI or a specific DCI format), or an idle UE can be indicated through paging or SI based DCI, or any other DCI or signal during idle mode, e.g., a paging early indicator DCI or sequence of the RACH configuration status.

In another embodiment, the UE may be pre-configured, or configured through higher layer signaling to associate the RACH configuration status with the RRC state it is in. E.g., if the UE is in RRC_connected mode, the UE assumes that the second RACH configuration is active. but if in RRC_idle/inactive, then the UE assumes by default the first RACH configuration is active, unless it is indicated or configured otherwise by the network.

In another embodiment which may be provided in a backwards-compatible manner, the RACH configuration for legacy UEs is provided in the traditional SIB1 framework with SI update, while advanced-capability UEs obtain RACH adaptation info via additional information elements either in SIB1 or another SIB without a SI update. In one example, the legacy configuration used by Rel-15-17 UEs may be set to a sparser value, e.g., 20-160 ms period which is also the sparse period for the later-release UEs. The denser configuration available to later-release UEs, e.g., 10 ms period, will overlap the sparse pattern RACH occasions. The preamble space is divided so that legacy and later-release UEs' preambles can be distinguished by the network. In a baseline approach of this embodiment, if a later-release preamble is detected, the later-release UEs' RACH configuration is modified (which these UEs can detect e.g., by polling the relevant SIB or monitoring DCI/MAC signaling) but not that of legacy UEs'. In a further elaborated approach, the legacy UEs' configuration may also be changed if the timer setting exceeds a threshold or time from the previous switch exceeds a threshold, or if the time instance of switching and the required SI update coincides with other gNB activity.

In one embodiment, one network has multiple RACH configurations implemented wherein different configurations are activated depending on a tradeoff between energy saving and performance. In one example, network change its RACH configuration from one to another wherein both configurations may be neither energy-optimal nor performance-optimal. In another example, network triggers a timer when it changes the RACH configuration. If no other preamble is received by the network until the timer runs out, the RACH configuration is restored to a predetermined PRACH configuration or the PRACH configuration may preserve the current configuration based on current traffic load and the number of UEs. In another example, the timer may be reset and restarted if any other preamble is received before the timer runs out.

In one class of embodiments, the adaptations between energy efficient vs performance optimized configurations are done based on past observations or time patterns derived from a network node's statistics, e.g., using AI/ML or other learning approaches based on observed periods (e.g., hours) of “few access attempts” (fewer than a threshold) vs “busy access attempts” (more accesses than a threshold). The RACH configuration switching mechanism may be adjusted by adapting e.g., the thresholds pertaining to the number of encountered preambles or timer settings based on the network node learning info. During hours of the day when there are many access attempts from the UEs, the configuration is adapted so that during those peak hours' configuration is performance optimized, e.g., by starting or adjusting the length of the performance-optimized timer.

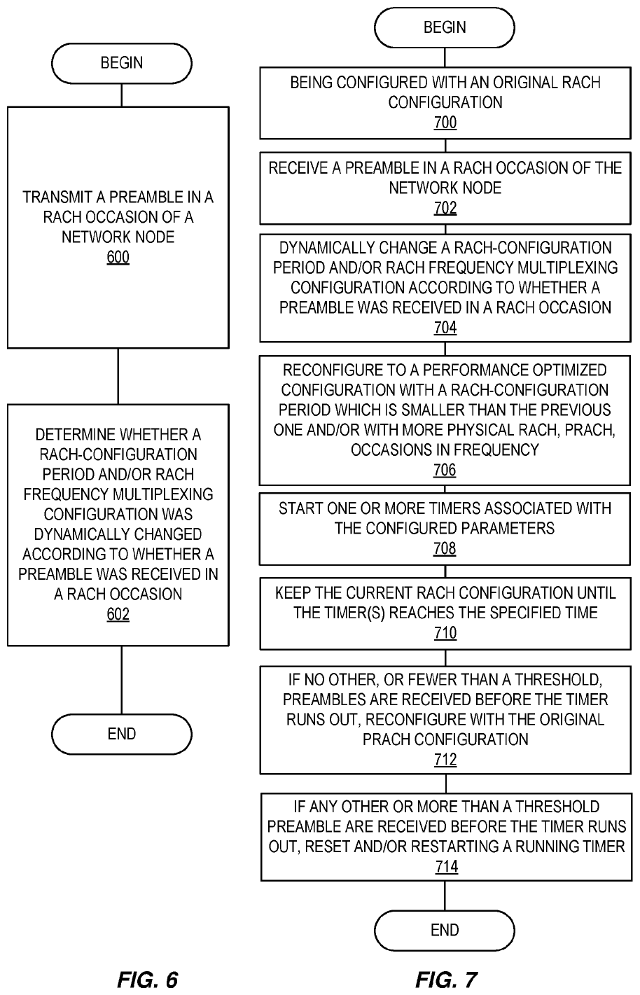

FIG. 6 illustrates a method performed by a user equipment for enabling energy efficient RACH. FIG. 7 illustrates a method performed by a network node for enabling energy efficient RACH.

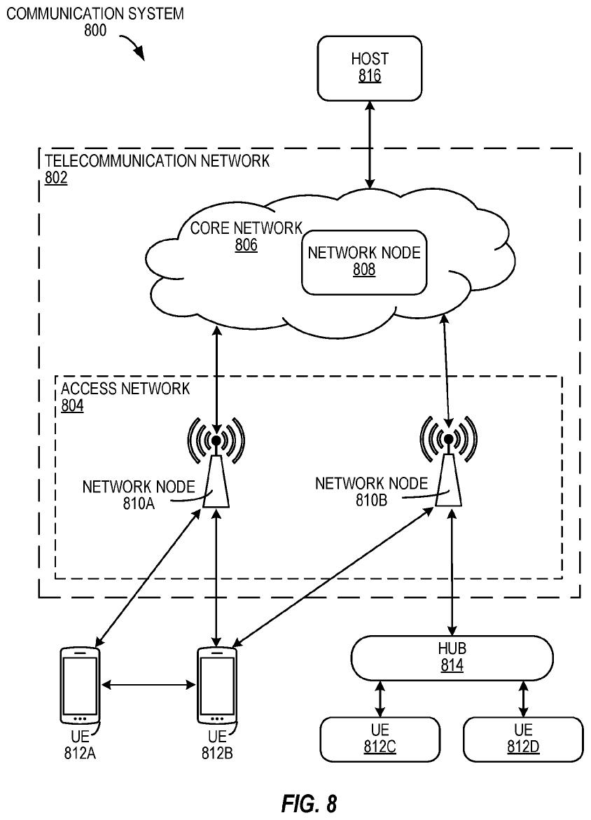

FIG. 8 shows an example of a communication system 800 in accordance with some embodiments.

In the example, the communication system 800 includes a telecommunication network 802 that includes an access network 804, such as a Radio Access Network (RAN), and a core network 806, which includes one or more core network nodes 808. The access network 804 includes one or more access network nodes, such as network nodes 810A and 810B (one or more of which may be generally referred to as network nodes 810), or any other similar Third Generation Partnership Project (3GPP) access node or non-3GPP Access Point (AP). The network nodes 810 facilitate direct or indirect connection of User Equipment (UE), such as by connecting UEs 812A, 812B, 812C, and 812D (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802 and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system 800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 802 is a cellular network that implements 3GPP standardized features. Accordingly, the telecommunication network 802 may support network slicing to provide different logical networks to different devices that are connected to the telecommunication network 802. For example, the telecommunication network 802 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IOT) services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single-or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 814 communicates with the access network 804 to facilitate indirect communication between one or more UEs (e.g., UE 812C and/or 812D) and network nodes (e.g., network node 810B). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a Virtual Reality (VR) headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810B. The hub 814 may also allow for a different communication scheme and/or schedule between the hub 814 and UEs (e.g., UE 812C and/or 812D), and between the hub 814 and the core network 806. In other examples, the hub 814 is connected to the core network 806 and/or one or more UEs via a wired connection. Moreover, the hub 814 may be configured to connect to a Machine-to-Machine (M2M) service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub-that is, a hub whose primary function is to route communications to/from the UEs from/to the network node 810B. In other embodiments, the hub 814 may be a non-dedicated hub-that is, a device which is capable of operating to route communications between the UEs and the network node 810B, but which is additionally capable of operating as a communication start and/or end point for certain data channels.

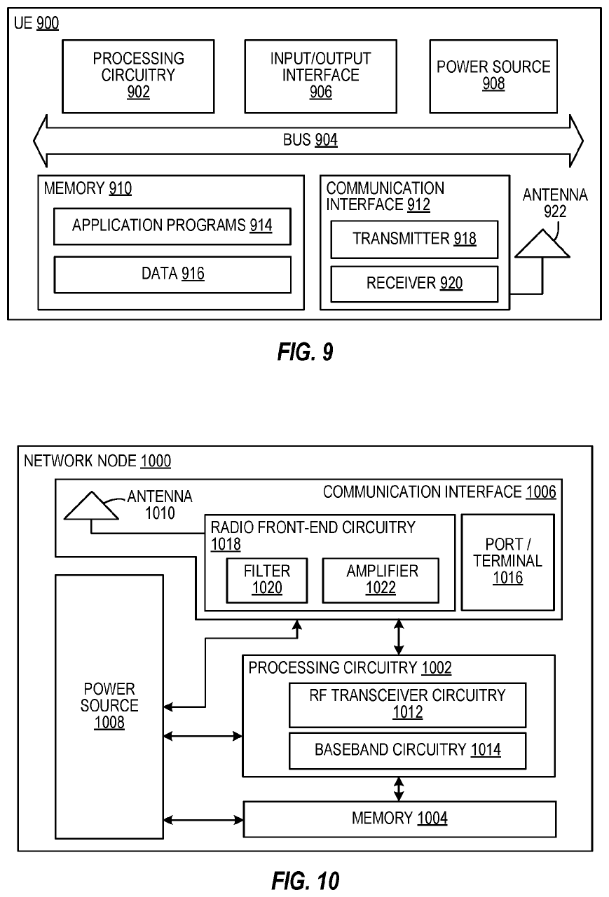

FIG. 9 shows a UE 900 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IOT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 902 may include multiple Central Processing Units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging the power source 908. Power circuitry may perform any formatting, converting, or other modification to the power from the power source 908 to make the power suitable for the respective components of the UE 900 to which power is supplied.

The memory 910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 910 may allow the UE 900 to access instructions, application programs, and the like stored on transitory or non-transitory memory media, to off-load data, or to upload data. An article of manufacture, such as one utilizing a communication system, may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., the antenna 922) and may share circuit components, software, or firmware, or alternatively be implemented separately.

In the illustrated embodiment, communication functions of the communication interface 912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 912, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 10 shows a network node 1000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes processing circuitry 1002, memory 1004, a communication interface 1006, and a power source 1008. The network node 1000 may be composed of multiple physically separate components (e.g., a Node B component and an RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1000 may be configured to support multiple RATs. In such embodiments, some components may be duplicated (e.g., separate memory 1004 for different RATs) and some components may be reused (e.g., an antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1000.

The processing circuitry 1002 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1000 components, such as the memory 1004, to provide network node 1000 functionality.

In some embodiments, the processing circuitry 1002 includes a System on a Chip (SOC). In some embodiments, the processing circuitry 1002 includes one or more of Radio Frequency (RF) transceiver circuitry 1012 and baseband processing circuitry 1014. In some embodiments, the RF transceiver circuitry 1012 and the baseband processing circuitry 1014 may be on separate chips (or sets of chips), boards, or units, such as radio units and digital units. In alternative embodiments, part or all of the RF transceiver circuitry 1012 and the baseband processing circuitry 1014 may be on the same chip or set of chips, boards, or units.

The memory 1004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and the memory 1004 are integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. The radio front-end circuitry 1018 comprises filters 1020 and amplifiers 1022. The radio front-end circuitry 1018 may be connected to the antenna 1010 and the processing circuitry 1002. The radio front-end circuitry 1018 may be configured to condition signals communicated between the antenna 1010 and the processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of the filters 1020 and/or the amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface 1006 may comprise different components and/or different combinations of components.

In certain alternative embodiments, the network node 1000 does not include separate radio front-end circuitry 1018; instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes the one or more ports or terminals 1016, the radio front-end circuitry 1018, and the RF transceiver circuitry 1012 as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, the communication interface 1006, and/or the processing circuitry 1002 may be configured to perform any receiving operations and/or certain obtaining operations described herein as being performed by the network node 1000. Any information, data, and/or signals may be received from a UE, another network node, and/or any other network equipment. Similarly, the antenna 1010, the communication interface 1006, and/or the processing circuitry 1002 may be configured to perform any transmitting operations described herein as being performed by the network node 1000. Any information, data, and/or signals may be transmitted to a UE, another network node, and/or any other network equipment.

The power source 1008 provides power to the various components of the network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid or an electricity outlet) via input circuitry or an interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

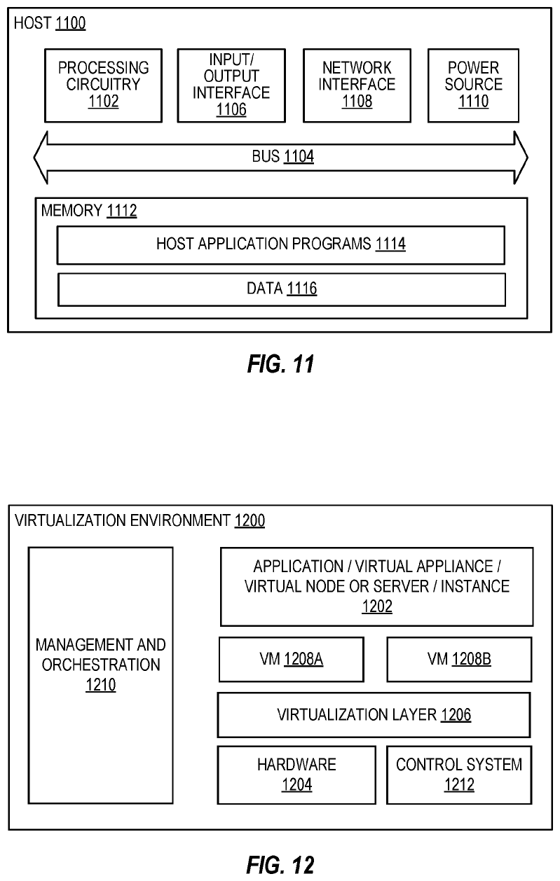

FIG. 11 is a block diagram of a host 1100, which may be an embodiment of the host 816 of FIG. 8, in accordance with various aspects described herein. As used herein, the host 1100 may be or comprise various combinations of hardware and/or software including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and memory 1112. Other components may be included in other embodiments. Features of these components may be substantially similar to those described with respect to the devices of previous figures, such as FIGS. 9 and 10, such that the descriptions thereof are generally applicable to the corresponding components of the host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for Over-The-Top (OTT) services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or VM Monitors (VMMs)), provide VMs 1208A and 1208B (one or more of which may be generally referred to as VMs 1208), and/or perform any of the functions, features, and/or benefits described in relation with some embodiments described herein. The virtualization layer 1206 may present a virtual operating platform that appears like networking hardware to the VMs 1208.

The VMs 1208 comprise virtual processing, virtual memory, virtual networking, or interface and virtual storage, and may be run by a corresponding virtualization layer 1206. Different embodiments of the instance of a virtual appliance 1202 may be implemented on one or more of the VMs 1208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1208 may be a software implementation of a physical machine that runs programs as if they were executing on a physical, non-virtualized machine. Each of the VMs 1208, and that part of the hardware 1204 that executes that VM, be it hardware dedicated to that VM and/or hardware shared by that VM with others of the VMs 1208, forms separate virtual network elements. Still in the context of NFV, a virtual network function is responsible for handling specific network functions that run in one or more VMs 1208 on top of the hardware 1204 and corresponds to the application 1202.

The hardware 1204 may be implemented in a standalone network node with generic or specific components. The hardware 1204 may implement some functions via virtualization. Alternatively, the hardware 1204 may be part of a larger cluster of hardware (e.g., such as in a data center or CPE) where many hardware nodes work together and are managed via management and orchestration 1210, which, among others, oversees lifecycle management of the applications 1202. In some embodiments, the hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1212 which may alternatively be used for communication between hardware nodes and radio units.

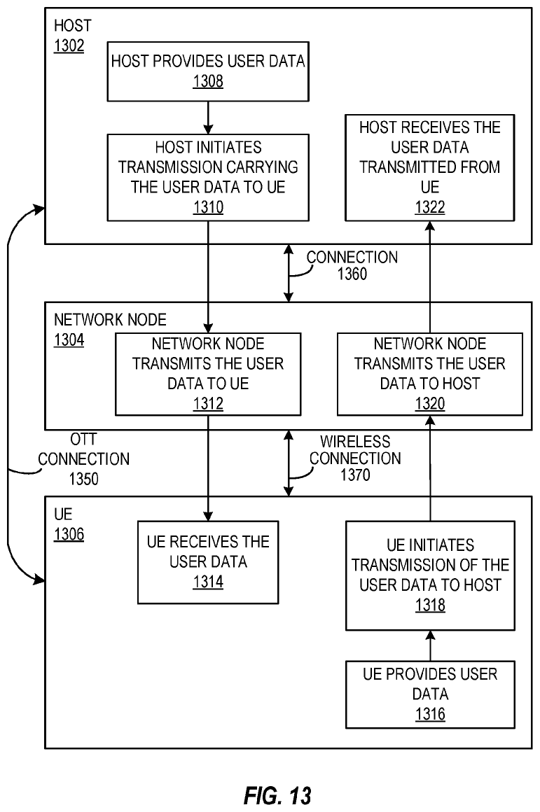

FIG. 13 shows a communication diagram of a host 1302 communicating via a network node 1304 with a UE 1306 over a partially wireless connection in accordance with some embodiments. Example implementations, in accordance with various embodiments, of the UE (such as the UE 812A of FIG. 8 and/or the UE 900 of FIG. 9), the network node (such as the network node 810A of FIG. 8 and/or the network node 1000 of FIG. 10), and the host (such as the host 816 of FIG. 8 and/or the host 1100 of FIG. 11) discussed in the preceding paragraphs will now be described with reference to FIG. 13.

Like the host 1100, embodiments of the host 1302 include hardware, such as a communication interface, processing circuitry, and memory. The host 1302 also includes software, which is stored in or is accessible by the host 1302 and executable by the processing circuitry. The software includes a host application that may be operable to provide a service to a remote user, such as the UE 1306 connecting via an OTT connection 1350 extending between the UE 1306 and the host 1302. In providing the service to the remote user, a host application may provide user data which is transmitted using the OTT connection 1350.

The network node 1304 includes hardware enabling it to communicate with the host 1302 and the UE 1306 via a connection 1360. The connection 1360 may be direct or pass through a core network (like the core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by the UE 1306 and executable by the UE's processing circuitry. The software includes a client application, such as a web browser or operator-specific “app” that may be operable to provide a service to a human or non-human user via the UE 1306 with the support of the host 1302. In the host 1302, an executing host application may communicate with the executing client application via the OTT connection 1350 terminating at the UE 1306 and the host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via the connection 1360 between the host 1302 and the network node 1304 and via a wireless connection 1370 between the network node 1304 and the UE 1306 to provide the connection between the host 1302 and the UE 1306. The connection 1360 and the wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304 in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR, or AR which it can broadcast, multicast, or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1350 between the host 1302 and the UE 1306 in response to variations in the measurement results. The measurement procedure and/or the network functionality for reconfiguring the OTT connection 1350 may be implemented in software and hardware of the host 1302 and/or the UE 1306. In some embodiments, sensors (not shown) may be deployed in or in association with other devices through which the OTT connection 1350 passes; the sensors may participate in the measurement procedure by supplying values of the monitored quantities exemplified above, or by supplying values of other physical quantities from which software may compute or estimate the monitored quantities. The reconfiguring of the OTT connection 1350 may include message format, retransmission settings, preferred routing, etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency, and the like by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

### EMBODIMENTS

### Group A Embodiments

Embodiment 1: A method performed by a user equipment for enabling energy efficient RACH, the method comprising one or more of: transmitting (600) a preamble in a RACH Occasion of a network node; and determining (602) whether a RACH-configuration period and/or RACH frequency multiplexing configuration was dynamically changed according to whether a preamble was received in a RACH Occasion.

Embodiment 2: The method of any of the previous embodiments, further comprising: providing user data; and forwarding the user data to a host via the transmission to the network node.

### Group B Embodiments

Embodiment 3: A method performed by a network node for enabling energy efficient RACH, the method comprising one or more of: being (700) configured with an original (e.g., energy efficient) RACH configuration; receiving (702) a preamble in a RACH Occasion of the network node; dynamically changing (704) a RACH-configuration period and/or RACH frequency multiplexing configuration according to whether a preamble was received in a RACH Occasion; reconfiguring (706) to a performance optimized configuration with a RACH-configuration period which is smaller than the previous one and/or with more PRACH occasions in frequency; starting (708) one or more timers associated with the configured parameters; keeping (710) the current (e.g., performance-optimized) RACH configuration until the timer(s) reaches the specified time; if no other or fewer than a threshold preamble are received before the timer runs out, reconfiguring (712) with the original (energy efficient) PRACH configuration; and if any other or more than a threshold preamble are received before the timer runs out, resetting (714) and/or restarting a running timer.

Embodiment 4: The method of embodiment 3, wherein configuration adaptation is based on/weighted towards type of the UE/access: a) Where adaptation from energy-optimized to performance-optimized configuration is done sooner (0 or a small threshold for number of UEs of such type accessing) in case a delay-sensitive UE accesses the network whereas such adaptation may take place later (higher threshold for number of user or no adaptation at all) in case a delay-tolerant type of UE accesses the NW; b) a)+Where the type of UE/access is identified by NW's higher layers during or after connection setup; and c) a)+where type of UE/access is identified by network upon UE access initiation based on access-specific preambles.

Embodiment 5: The method of any of embodiments 3 to 4, in which the said adaptations between energy efficient vs performance optimized configurations are done based on time schedules derived from a network node's learnings of “few access attempt”-hours (fewer than a threshold) vs “busy access attempt”-hours (more accesses than a threshold).

Embodiment 6: The method of any of embodiments 3 to 5, wherein the number of preambles thresholds or timer settings are adapted based on the network node learning info.

Embodiment 7: The method of any of the previous embodiments, further comprising: obtaining user data; and forwarding the user data to a host or a user equipment. Group C Embodiments

Embodiment 8: A user equipment for enabling energy efficient RACH, comprising: processing circuitry configured to perform any of the steps of any of the Group A embodiments; and power supply circuitry configured to supply power to the processing circuitry.

Embodiment 9: A network node for enabling energy efficient RACH, the network node comprising: processing circuitry configured to perform any of the steps of any of the Group B embodiments; power supply circuitry configured to supply power to the processing circuitry.

Embodiment 10: A user equipment (UE) for enabling energy efficient RACH, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 11: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 12: The host of the previous embodiment, wherein the cellular network further includes a network node configured to communicate with the UE to transmit the user data to the UE from the host.

Embodiment 13: The host of the previous 2 embodiments, wherein: the processing circuitry of the host is configured to execute a host application, thereby providing the user data; and the host application is configured to interact with a client application executing on the UE, the client application being associated with the host application.

Embodiment 14: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 15: The method of the previous embodiment, further comprising: at the host, executing a host application associated with a client application executing on the UE to receive the user data from the UE.

Embodiment 16: The method of the previous embodiment, further comprising: at the host, transmitting input data to the client application executing on the UE, the input data being provided by executing the host application, wherein the user data is provided by the client application in response to the input data from the host application.

Embodiment 17: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 18: The host of the previous embodiment, wherein the cellular network further includes a network node configured to communicate with the UE to transmit the user data from the UE to the host.

Embodiment 19: The host of the previous 2 embodiments, wherein: the processing circuitry of the host is configured to execute a host application, thereby providing the user data; and the host application is configured to interact with a client application executing on the UE, the client application being associated with the host application.

Embodiment 20: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 21: The method of the previous embodiment, further comprising: at the host, executing a host application associated with a client application executing on the UE to receive the user data from the UE.

Embodiment 22: The method of the previous embodiment, further comprising: at the host, transmitting input data to the client application executing on the UE, the input data being provided by executing the host application, wherein the user data is provided by the client application in response to the input data from the host application.

Embodiment 23: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 24: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 25: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 26: The method of the previous embodiment, further comprising, at the network node, transmitting the user data provided by the host for the UE.

Embodiment 27: The method of any of the previous 2 embodiments, wherein the user data is provided at the host by executing a host application that interacts with a client application executing on the UE, the client application being associated with the host application.

Embodiment 28: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 29: The communication system of the previous embodiment, further comprising: the network node; and/or the user equipment.

Embodiment 30: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 31: The host of the previous 2 embodiments, wherein: the processing circuitry of the host is configured to execute a host application, thereby providing the user data; and the host application is configured to interact with a client application executing on the UE, the client application being associated with the host application.

Embodiment 32: The host of the any of the previous 2 embodiments, wherein the initiating receipt of the user data comprises requesting the user data.

Embodiment 33: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 34: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a network node for enabling an energy efficient Random Access Channel (RACH), the network node being configured with an original RACH configuration, the method comprising:
receiving a preamble in a RACH Occasion of the network node;
dynamically changing a RACH-configuration period and/or RACH frequency multiplexing configuration according to whether the preamble was received in the RACH Occasion;
reconfiguring to a performance optimized configuration with a RACH-configuration period which is smaller than the previous one and/or with more Physical RACH, PRACH, occasions in frequency;
starting one or more timers associated with the configured parameters;
keeping the current RACH configuration until the one or more timers reaches a specified time;
if no other preamble or fewer than a threshold number of preambles are received before the one or more timer(s) runs out, reconfiguring with the original RACH configuration; and
if any other preamble or more than a threshold number of preambles are received before the one or more timers runs out, resetting and/or restarting a running timer.

2. The method of claim 1, wherein the original RACH configuration comprises an energy efficient RACH configuration.

3. The method of claim 1, wherein the current RACH configuration comprises a performance-optimized RACH configuration.

4. The method of claim 1, wherein a configuration adaptation is based on/weighted towards a type of a User Equipment (UE) access when one or more of:
adaptation from an energy-efficient to the performance-optimized configuration is done sooner when a delay-sensitive UE accesses a network whereas such adaptation may take place later in case a delay-tolerant type of UE accesses the network;
the type of UE/access is identified by the network's higher layers during or after connection setup; and
the type of UE/access is identified by the network upon UE access initiation based on access-specific preambles.

5. The method of claim 1, wherein configuration being performed sooner comprises performing when zero or a small number of UEs of the identified type is accessing the network.

6. The method of claim 1, wherein configuration being performed later comprises performing when a higher threshold for number of users or no adaptation at all.

7. The method of claim 1, in which the adaptations between the energy efficient and the performance optimized configurations are done based on time schedules derived from the network node's learnings of “few access attempt”-hours versus “busy access attempt”-hours.

8. The method of claim 7, wherein the “few access attempt”-hours comprise fewer than a threshold and the “busy access attempt”-hours comprise more accesses than the threshold.

9. The method of claim 1, wherein a number of preamble thresholds or timer settings is adapted based on network node learning information.

10. (canceled)

11. A method performed by a User Equipment (UE) for enabling an energy efficient Random Access Channel (RACH), the method comprising:
transmitting a preamble in a RACH Occasion of a network node; and
determining whether a RACH-configuration period and/or RACH frequency multiplexing configuration was dynamically changed according to whether a preamble was received in a RACH Occasion.

12. The method of claim 11, wherein a RACH-configuration comprises one of the group consisting of: an energy efficient RACH configuration; and a performance-optimized RACH configuration.

13. The method of claim 11, wherein configuration adaptation is based on/weighted towards a type of UE/access when one or more of:
adaptation from energy-efficient to the performance-optimized configuration is done sooner when a delay-sensitive UE accesses a network whereas such adaptation may take place later in case a delay-tolerant type of UE accesses the network;
the type of UE/access is identified by the network's higher layers during or after connection setup; and
the type of UE/access is identified by the network upon UE access initiation based on access-specific preambles.

14. The method of claim 11, wherein configuration being performed sooner comprises performing when zero or a small number of UEs of the identified type is accessing the network.

15. The method of claim 11, wherein configuration being performed later comprises performing when a higher threshold for number of users or no adaptation at all.

16. The method of claim 11, in which the adaptations between the energy efficient and the performance optimized configurations are done based on time schedules derived from the network node's learnings of “few access attempt”-hours vs “busy access attempt”-hours.

17. The method of claim 16, wherein the “few access attempt”-hours comprise fewer than a threshold and the “busy access attempt”-hours comprise more accesses than the threshold.

18. (canceled)

19. (canceled)

20. A network node for enabling an energy efficient Random Access Channel (RACH), the network node being configured with an original RACH configuration, the network node comprising:
processing circuitry; and
memory comprising instructions to cause the network node to perform the steps of:
receive a preamble in a RACH Occasion of the network node;
dynamically change a RACH-configuration period and/or RACH frequency multiplexing configuration according to whether the preamble was received in the RACH Occasion;
reconfigure to a performance-optimized configuration with a RACH-configuration period which is smaller than the previous one and/or with more Physical RACH (PRACH) occasions in frequency;
start one or more timers associated with the configured parameters;
keep the current RACH configuration until the one or more timers reaches a specified time;
if no other preamble or fewer than a threshold number of preambles are received before the one or more timers runs out, reconfigure with the original RACH configuration; and
if any other preamble or more than a threshold number of preambles are received before the one or more timers runs out, resetting and/or restarting a running timer.

21. (canceled)

22. A User Equipment (UE) for enabling an energy efficient Random Access Channel (RACH) the UE comprising:
processing circuitry; and
memory storing instructions executable by the processing circuitry, whereby the UE is operable to:
transmit a preamble in a RACH Occasion of a network node; and
determine whether a RACH-configuration period and/or RACH frequency multiplexing configuration was dynamically changed according to whether the preamble was received in the RACH Occasion.

23. (canceled)

24. (canceled)
